(19) United States
(12) Patent Application Publication
(10) Pub. No.: US 2015/0066383 A1
(43) Pub. Date: Mar. 5, 2015

(54) COLLAPSIBLE MODULAR GENOMIC PIPELINE

(71) Applicant: Seven Bridges Genomics Inc., Cambridge, MA (US)

(72) Inventor: Sebastian Wernicke, Munich (DE)

(73) Assignee: Seven Bridges Genomics Inc., Cambridge, MA (US)

(21) Appl. No.: 14/016,774

(22) Filed: Sep. 3, 2013

(51) Int. Cl. G06F 19/22

(52) U.S. Cl. CPC G06F 19/22
USPC 702/20

(57) ABSTRACT

The invention generally relates to tools for genomic analysis and particularly to a pipeline editor that can turn pipelines into standalone tools for use in other pipelines. The invention provides systems and methods for genomic analysis in which individual analytical tools can be arranged into analytical pipelines that can then be “collapsed” into standalone tools, which themselves can be put into the pool of individual tools for use in further building of pipelines. Aspects of the invention provide a system that includes a server computer system operable to present to a user a plurality of genomic tools, receive input from the user arranging the tools into a pipeline, create a new tool that includes the pipeline, and offer the new tool along with the plurality of genomic tools.

### FIELD OF THE INVENTION

The invention generally relates to tools for genomic analysis and particularly to a pipeline editor that can convert pipelines into standalone tools for use in other pipelines.

### BACKGROUND

A person suffering from a genetic disorder can face a lifetime of disability. For example, phenylketonuria (PKU) is a genetic condition in which the amino acid phenylalanine is not metabolized correctly. If PKU is not detected, the person may suffer from severe developmental disabilities, seizures, and other serious medical problems. Fortunately, many such genetic conditions can now be detected early by genetic screening.

Genome sequencing technology has the potential to screen a very large number of people for genetic conditions. So-called next generation sequencing (NGS) technologies can now routinely sequence entire genomes within days and for a low cost. Sequencing whole genomes potentially provides benefits not offered by existing gene-specific genetic tests. For example, with whole genome sequencing, many disorders can be checked for at once and the data can be re-checked for any new significant variants that are later identified without having to run another test. Genome sequencing can also reveal structural variations, which are proving to have medical significance as more instances of such variations are detected. Unfortunately, the availability of NGS throughput has not made genetic screening universally accessible. While more and more clinics have access to NGS sequencing capacity, they are faced with a very high volume of data that is imperfect and not trivial to analyze.

The path from sequencer output to clinically significant information can be difficult even for a skilled geneticist or an academic researcher. Sequencer output is typically in the form of data files for individual sequence reads. Depending on the project goals, these reads may need to be quality checked, assembled, aligned, compared to the literature or to databases, segregated from one another by allele, evaluated for non-Mendelian heterozygosity, or subject to any of many other analyses. Sometimes the bioinformatician who can detect meaningful patterns in data is not available to a physician who is counseling a patient. In some cases, a researcher may create an algorithm that's particularly good at detecting a particular type of variant, such as, for example, copy number variation in Short Tandem Repeat sections of the genome, which are implicated in a number of different disorders, but clinics in the field will lack the programming skills to develop modules to analyze their existing data to detect that variant in their patients. Due to that non-trivial jump from data analysis to real-world use, the potential for NGS technology to alleviate suffering is not yet being realized fully.

### SUMMARY

The invention provides systems and methods for genomic analysis in which individual analytical tools can be arranged into analytical pipelines that can then be “collapsed” into standalone tools, which themselves can be put into the pool of individual tools for use in further building of pipelines. Using the system, a researcher can design a complex analytical algorithm—or pipeline—that includes any combination of existing tools such as, for example, sequence assembly and alignment. The newly-designed pipeline can be assembled, represented, and executed within a pipeline editor that can appear with a graphical interface allowing intuitive assembly of the tools into genomic analysis pipelines (e.g., by drag-and-drop assembly of icons representing the tools). The system can treat the pipeline as a module with specific functionality and can “collapse” the pipeline into a single tool that also appears within the pipeline editor. In this way, once the researcher has solved a particular problem, the analytical solution is stored for re-use and can be incorporated as a module within a larger, over-arching analytical project or can be distributed for use by other users of the system.

Since the complex analytical algorithm is embodied in the now-standalone tool, downstream users can incorporate the provided solution into their analyses without recreating the pipeline de novo. Since the original tools and the new pipeline tool can be represented in a graphical pipeline editor (for example, using icons), the system allows users to concentrate on the medical or scientific significance in their data without undue difficulty in programming complex algorithms. Since the new pipeline tool is recognized by the system as if it were one of the original tools, the collapsing and embedding can be recursive. For example, one user can solve a difficult problem with quality control. Another user could incorporate the quality control pipeline into a read assembly pipeline and embed that into a variant calling pipeline. A physician could build a database comparison and reporting pipeline that incorporates the variant calling pipeline. Since the system creates each new pipeline tool to include the exact functionality of the tools that go into the underlying pipeline, each standalone pipeline—when used or executed—will faithfully perform the analysis designed by the worker that produced the pipeline. Thus, the system allows high volumes of sequence data to be analyzed in a modular fashion in which experts for different analytical steps can create pipelines that serve the appropriate analytical purpose, and the system also allows one or more of the created pipelines to be made available for use as tools in other pipelines, all within the context of an intuitive graphical interface that can have an app-style presentation using drag-and-drop icons to represent individual analytical tools. The system facilitates the contribution by different specialized experts to genomic analysis, which allows end-users such as medical clinics or small research labs to benefit from the contributions of programmers and bioinformaticians who have already solved particular problems. Also, the system contributes to the reproducibility of results, since analytical approaches can be embodied in tools that are later accessible through the system. Additionally, since pipelines, and the analytical solutions they embody, are provided as modular, executable computer tools, they can be shared, accessed, used, and invoked through methods such as hyper-linking, tagging, at-referencing, or embedding within documents.

In certain aspects, the invention provides a system for genomic analysis. The system includes a server computer system operable to present to a user a plurality of genomic tools, receive input from the user arranging the tools into a pipeline, create a new tool that includes the pipeline, and offer the new tool along with the plurality of genomic tools. Each genomic tool may be presented by using an icon displayed in a web browser on a user computer device connected to the server computer system. The input arranging the tools may include dragging and dropping the tools within a graphical interface.

Preferably, the system is further operable by the user to create an additional pipeline that includes the new tool, create an additional tool that includes the additional pipeline, and offer the plurality of genomic tools, the new tool, and the additional tool for arrangement into genomic pipelines by displaying an icon for each of the plurality of tools, the new tool, and the additional tool in a graphical interface. Any suitable genomic tool may be included. For example, any one of the genomic tools may be operable to: obtain nucleotide sequence data from sequence read files, align nucleotide sequence data, compare sequence reads to a reference, or a combination thereof. In certain embodiments, the system will receive nucleotide sequence data from a remote source computer, instruct a remote cloud computer to use the plurality of genomic tools to analyze the nucleotide sequence data, and deliver output genomic information to a remote user computer.

In certain embodiments, offering the new tool along with the plurality of genomic tools can be done by representing each of the plurality of tools and the new tool using icons in a graphical pipeline editor on a user terminal. The new tool may be represented using a new icon that is clicked to execute the pipeline. They system can provide the pipeline editor for the user to use to arrange the icons into a different pipeline. The system may be further operable to represent inputs and outputs of tools graphically, and to represent inputs and outputs of pipelines in the same way that inputs and outputs of tools are represented.

In related aspects, the invention provides a method for genomic analysis. The method includes using a server system comprising a processor coupled to a memory to create and collapse pipelines within a pipeline editor. To assist a user in creating a pipeline, the server system is operable to present to a user a plurality of genomic tools, receive input from the user arranging the tools into a pipeline, create a new tool that includes the pipeline, and offer the new tool along with the plurality of genomic tools.

Aspects of the invention provide systems and methods for genomic analysis that use a processor coupled to memory containing instructions operable to cause a computer system to present a user interface that presents a plurality of tools. The user interface is operable by a user to assemble individual ones of the plurality of tools into a pipeline, create a new pipeline tool that provides the same functionality as the pipeline, and present the new pipeline tool with the plurality of tools. Each of the plurality of tools and the new pipeline tool includes instructions operable to cause the system to receive a predetermined genomic data input, change the genomic data input, and output new genomic data. The user interface may present a display including an icon that can be dragged and dropped into a pipeline area of the display. In some embodiments, icons can be connected to one another by a user to cause the system to use the connected tools to analyze genomic data.

By connecting a plurality of tools, a user creates a new pipeline. The user can then turn the new pipeline into a new pipeline tool. The new pipeline tool may be made by creating instructions that route input data to the first tool in the pipeline, and through the subsequent tools in the pipeline.

The new pipeline tool can then be presented to the user by, for example, displaying an icon for the tool that can be dragged into the pipeline area. Any of the pipeline tools, including the new pipeline tool, can be linked to any one or more of each other to create other pipeline. Additionally, other pipelines can be stored as new tools within the plurality of tools. In some embodiments, when a user clicks on the new tool icon, the pipeline is executed. In certain embodiments, pipelines can be executed from documents and accessed via links. Additionally or alternatively, a pipeline or a tool can be compiled and offered as an executable program for download by a user.

### BRIEF DESCRIPTION OF THE DRAWINGS

FIG. 1 illustrates a pipeline editor according to some embodiments.

FIG. 2 diagrams a system according to certain embodiments.

FIG. 3 depicts a tool icon.

FIG. 4 gives a display presented by the pipeline editor.

FIG. 5 illustrates a connector.

FIG. 6 shows a graphical representation of collapsing a pipeline.

FIG. 7 illustrates how a tool may be brought into the pipeline editor.

FIG. 8 illustrates components of a system.

FIG. 9 illustrates the operation and inter-relation of the components of the system.

FIG. 10 illustrates a relatively simple pipeline.

FIG. 11 shows a pipeline for differential expression analysis.

FIG. 12 shows a pipeline for providing an alignment summary.

FIG. 13 depicts a pipeline for split read alignment.

### DETAILED DESCRIPTION

The invention generally relates to genetic data analysis and discovery. Methods and systems of the invention include computer systems that provide a genomic analysis pipeline editor and computing resources for performing the analyses represented by the pipelines. Computing execution and storage can be provided by one or more server computers of the system, by an affiliated cloud resource, by a user's local computing hardware, or by a combination thereof. It may be found preferable to use a cloud resource for execution and storage, particularly where processing and storage demand fluctuates rapidly and unpredictably.

Methods and systems of the invention may provide a pipeline editor using an intuitive graphical user interface (GUI). A user can access the GUI to compose one or more genetic pipeline or to use analytical tools provided from within the system. System resources can assemble the tools required by a pipeline to embody the pipeline within executable code. The system computer resources or the affiliated cloud resources can execute the code to analyze genetic data as described by the pipeline. In this way, systems of the invention can be used for analyzing genetic data generated through next-generation sequencing (NGS) technologies.

The invention provides an interface for managing NGS data analysis projects. The interface includes a pipeline editor that allows a user to create and run genomic analysis. Preferably, the pipeline editor operates via a drag-and-drop interface. Using connections to online processing or storage, the invention provides highly scalable computation and the means to easily consume, share, and reproduce results.

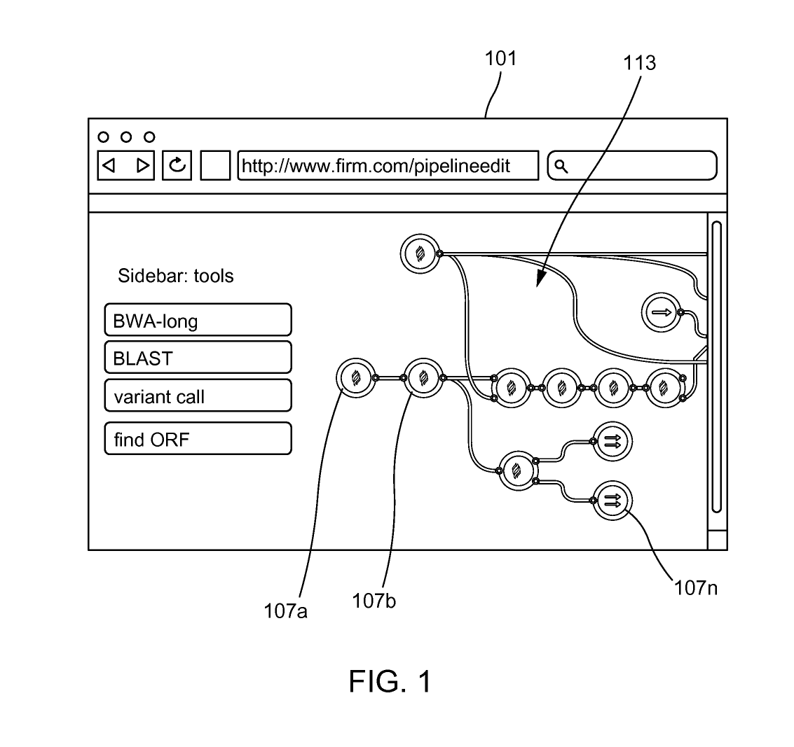

FIG. 1 illustrates a pipeline editor 101 according to some embodiments. Pipeline editor 101 may be presented in any suitable format such as a dedicated computer application or as a web site accessible via a web browser. Generally, pipeline editor 101 will present a work area in which a user can see and access icons representing a plurality of tools 107a, 107b, . . . , 107n. As shown in FIG. 1, each tool 107 is part of a pipeline 113. In general, a tool 107 will have at least one input or output that can be linked to one or more input or output of another tool 107. A set of linked tools may be referred to as a pipeline.

A pipeline generally refers to a bioinformatics workflow that includes one or a plurality of individual steps. Each step (embodied and represented as a tool 107 within pipeline editor 101) generally includes an analysis or process to be performed on genetic data. For example, an analytical project may begin by obtaining a plurality of sequence reads. The pipeline editor 101 can provide the tools to quality control the reads and then to assemble the reads into contigs. The contigs may then be compared to a references, such as the human genome (e.g., hg18) to detect mutations by a third tool. These three tools—quality control, assembly, and compare to reference—as used on the raw sequence reads represent but one of myriad genomic pipelines. Genomic pipelines are discussed in the international patent application SYSTEM AND METHOD FOR PROCESSING BIO INFORMATION ANALYSIS PIPELINE by Korea Institute of Science and Technology, published as WO 2013/035904.

As represented in FIG. 1, each step is provided as a tool 107. Any tool 107 may perform any suitable analysis such as, for example, alignment, variant calling, RNA splice modeling, quality control, data processing (e.g., of FASTQ, BAM/SAM, or VCF files), or other formatting or conversion utilities. Pipeline editor 101 represents tools 107 as “apps” and allows a user to assemble tools into a pipeline 113.

Small pipelines can be included that use but a single app, or tool. For example, editor 101 can include a merge FASTQ pipeline that can be re-used in any context to merge FASTQ files. Complex pipelines that include multiple interactions among multiple tools (e.g., such as a pipeline to call variants from single samples using BWA+GATK) can be created to store and reproduce published analyses so that later researchers can replicate the analyses on their own data.

Using the pipeline editor 101, a user can browse stored tools and pipelines to find a stored tool 107 of interest that offers desired functionality. The user can then copy the tool 107 of interest into a project, then run it as-is or modify it to suit the project. Additionally, the user can build new analyses from scratch. Once pipeline 113 is assembled, the invention provides systems and methods for creating a new tool 107 representing the functionality of pipeline 113, discussed in more detail below. Once pipeline 113 is assembled in pipeline editor 101 and optionally “collapsed” into a single, standalone tool 107, pipeline 113 provides a ready-to-run bioinformatic analysis workflow.

Embodiments of the invention can include server computer systems that provide pipeline editor 101 as well as computing resources for performing the analyses represented by pipeline 113. Computing execution and storage can be provided by one or more server computers of the system, by an affiliated cloud resource, by a user's local computer resources, or a combination thereof.

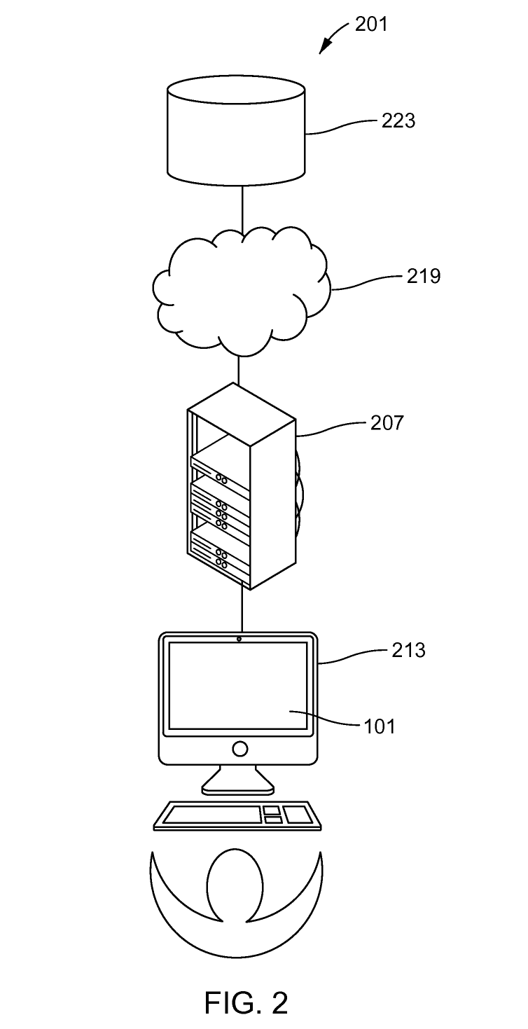

FIG. 2 diagrams a system 201 according to certain embodiments. System 201 generally includes a server computer system 207 to provide functionality such as access to one or more tools 107. A user can access pipeline editor 101 and tools 107 through the use of a local computer 213. A pipeline module on server 207 can invoke the series of tools 107 called by a pipeline 113. A tool module can then invoke the commands or program code called by the tool 107. Commands or program code can be executed by processing resources of server 207. In certain embodiments, processing is provided by an affiliated cloud computing resource 219. Additionally, affiliated storage 223 may be used to store data.

A user can interaction with pipeline editor 101 through a local computer 213. Local computer 213 can be a laptop, desktop, or mobile device such as a tablet or smartphone. In general, local computer 213 is a computer device that includes a memory coupled to a processor with one or more input/output mechanism. Local computer 213 communicates with server 207, which is generally a computer that includes a memory coupled to a processor with one or more input/output mechanism. These computing devices can optionally communicate with affiliated resource 219 or affiliated storage 223, each of which preferably use and include at least computer comprising a memory coupled to a processor.

As one skilled in the art would recognize as necessary or best-suited for performance of the methods of the invention, systems of the invention include one or more computer devices that include one or more processors (e.g., a central processing unit (CPU), a graphics processing unit (GPU), etc.), computer-readable storage devices (e.g., main memory, static memory, etc.), or combinations thereof which communicate with each other via a bus. A computer generally includes at least one processor coupled to a memory via a bus and input or output devices.

A processor may be any suitable processor known in the art, such as the processor sold under the trademark XEON E7 by Intel (Santa Clara, Calif.) or the processor sold under the trademark OPTERON 6200 by AMD (Sunnyvale, Calif.).

Memory preferably includes at least one tangible, non-transitory medium capable of storing: one or more sets of instructions executable to cause the system to perform functions described herein (e.g., software embodying any methodology or function found herein); data (e.g., embodying any tangible physical objects such as the genetic sequences found in a patient's chromosomes); or both. While the computer-readable storage device can in an exemplary embodiment be a single medium, the term “computer-readable storage device” should be taken to include a single medium or multiple media (e.g., a centralized or distributed database, and/or associated caches and servers) that store the instructions or data. The term “computer-readable storage device” shall accordingly be taken to include, without limit, solid-state memories (e.g., subscriber identity module (SIM) card, secure digital card (SD card), micro SD card, or solid-state drive (SSD)), optical and magnetic media, and any other tangible storage media.

Any suitable services can be used for affiliated resource 219 or affiliated storage 223 such as, for example, Amazon Web Services. In some embodiments, affiliated storage 223 is provided by Amazon Elastic Block Store (Amazon EBS) snapshots, allowing cloud resource 219 to dynamically mount Amazon EBS volumes with the data needed to run pipeline 113. Use of cloud storage 223 allows researchers to analyze data sets that are massive or data sets in which the size of the data set varies greatly and unpredictably. Thus, systems of the invention can be used to analyze, for example, hundreds of whole human genomes at once.

Input/output devices according to the invention may include a video display unit (e.g., a liquid crystal display (LCD) or a cathode ray tube (CRT) monitor), an alphanumeric input device (e.g., a keyboard), a cursor control device (e.g., a mouse or trackpad), a disk drive unit, a signal generation device (e.g., a speaker), a touchscreen, an accelerometer, a microphone, a cellular radio frequency antenna, and a network interface device, which can be, for example, a network interface card (NIC), Wi-Fi card, or cellular modem.

As shown in FIG. 1, within pipeline editor 101, individual tools (e.g., command line tools) are represented as an icon in a graphical editor.

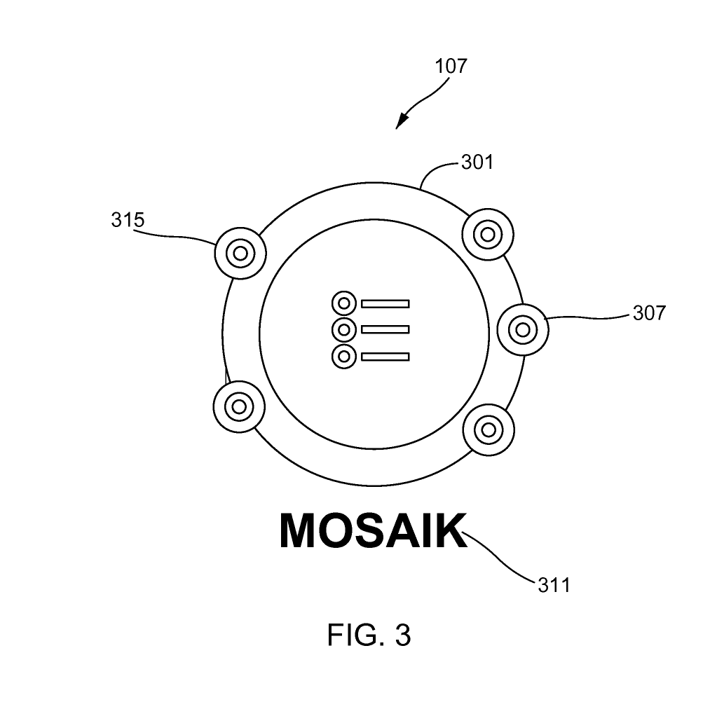

FIG. 3 depicts a tool 107, shown represented as an icon 301. Any icon 301 may have one or more output point 307 and one or more input point 315. In embodiments in which an icon 301 represents an underlying command (such as a UNIX/LINUX command), input point 315 is analogous to an argument that can be piped in and output point 307 represents the output of the command. Icon 301 may be displayed with a label 311 to aid in recognizing tool 107. Clicking on the icon 301 for tool 107 allows parameters of the tool to be set within pipeline editor 101.

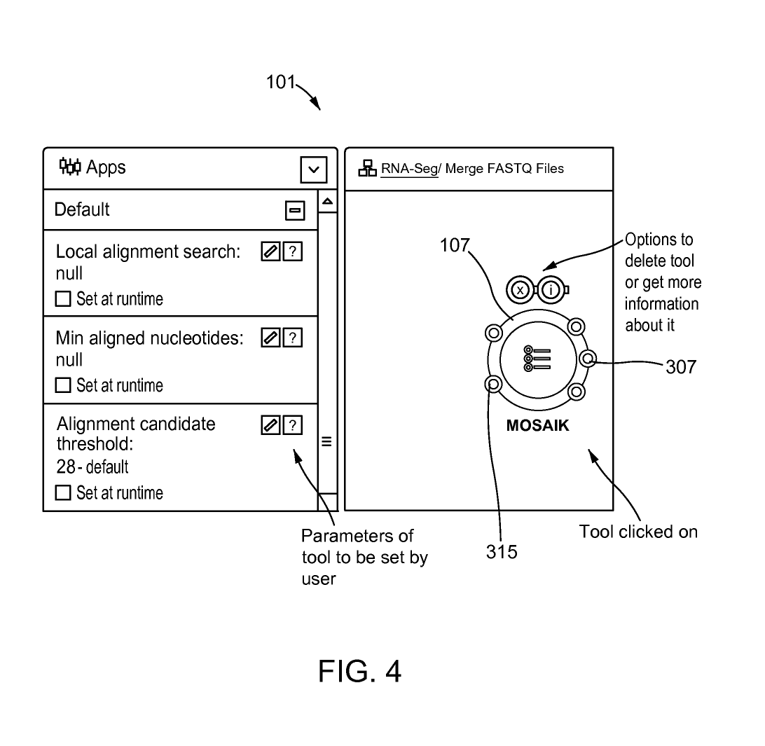

FIG. 4 gives a display presented by pipeline editor 101 when a tool 107 is selected. The tool may include buttons for deleting that tool or getting more information associated with the icon 301. Additionally, a list of parameters for running the tool may be displayed with elements such as tick-boxes or input prompts for setting the parameters (e.g., analogous to switches or flags in UNIX/LINUX commands). Clicking on tool 107 allows parameters of the tool to be set within editor 101 (e.g., within a GI). As discussed in more detail below, the parameter settings will then be passed through the tool module to the command-level module. A user may build pipeline 113 by placing connectors between input points 315 and output points 307.

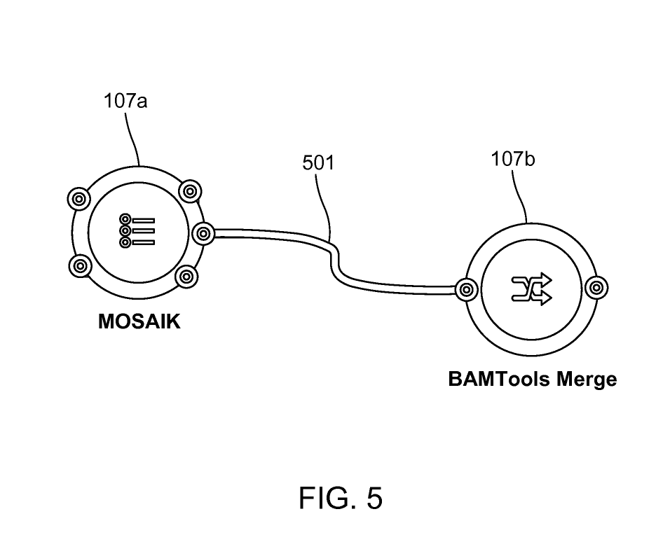

FIG. 5 illustrates a connector 501 connecting a first tool 107a to a second tool 107b. connector 501 represents a data-flow from first tool 107a to second tool 107b (e.g., analogous to the pipe (I) character in UNIX/LINUX text commands).

As discussed above, once a pipeline 113 is built in pipeline editor 101, it may be “collapsed” to create a new tool 107, which may be given its own icon 301.

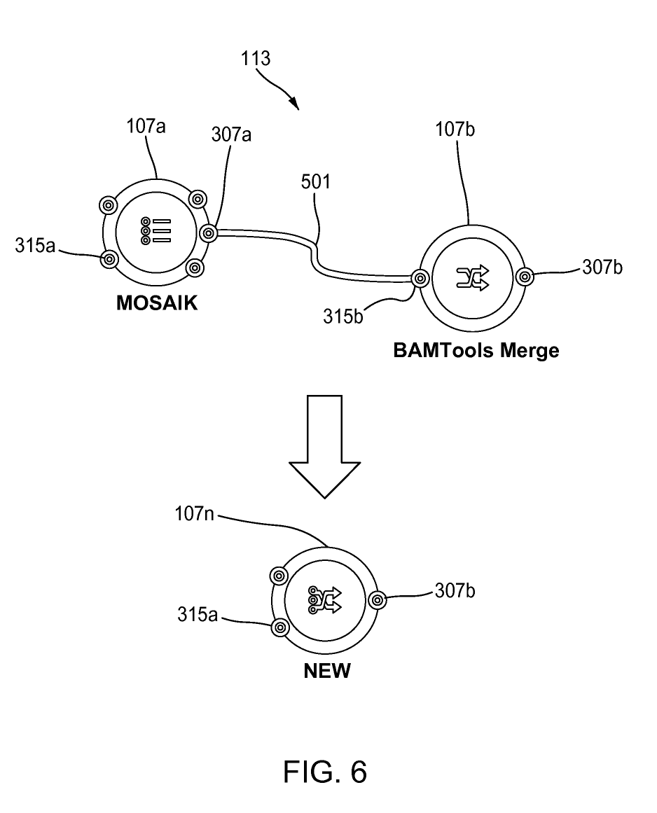

FIG. 6 shows a graphical representation of collapsing a pipeline 113 to form a new tool 107n. Here, pipeline 113 includes first tool 107a connected to second tool 107b via connector 501 from output point 307a on first tool 107a to input point 315b on second tool 107b. Since pipeline 113 starts and ends with first tool 107a and second tool 107b, respectively, the input and output points of pipeline 113 are input points 315a and output points 307b, respectively. New tool 107n has only input points 315a and output points 307b because new tool 107n offers the same functionality as pipeline 113.

In this way, system 201 is operable to represent an entire pipeline 113 as an icon 301 in the pipeline editor 101 in the same way that the individual tools 107 that make up pipeline 113 are represented. Thus the new tool 107 includes the original pipeline 113. The new tool 107 is then offered as one among the tools that are offered within pipeline editor 101.

Remembering that the new tool 107 embodies the pipeline 113, inputs and outputs of the entire pipeline 113 are thus represented in the same way as inputs and outputs of any tool are represented, e.g., as input points 315 and output points 307 on icon 301 for new tool 107. Additionally, new tool 107 and the pipeline it represents may be incorporated into other pipelines the same way that any of the other tools may be incorporated.

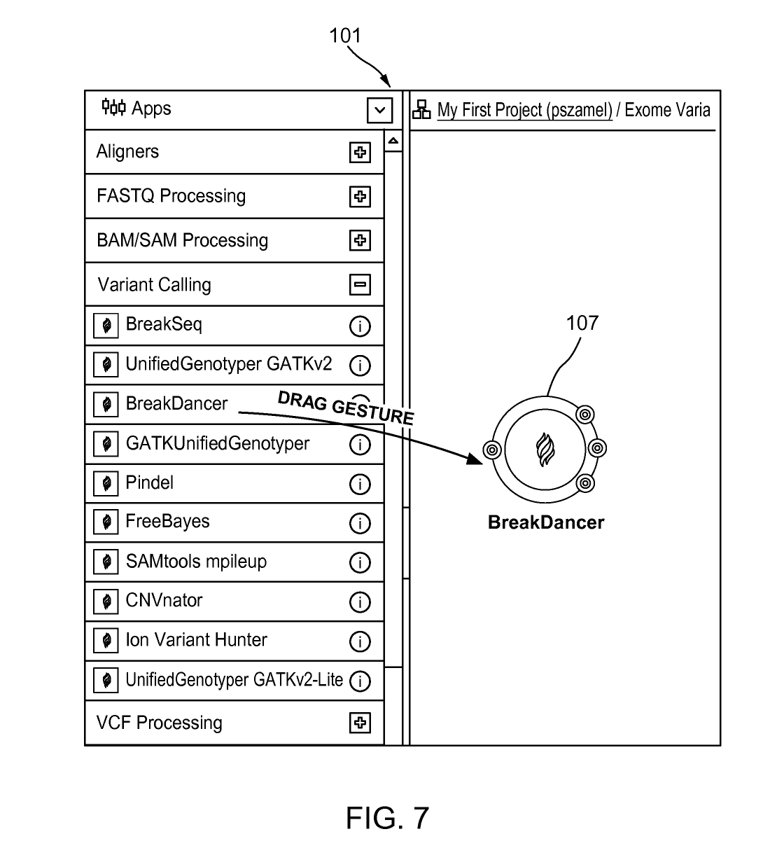

FIG. 7 illustrates how a tool 107 may be brought into pipeline editor 101 for use within the editor. In some embodiments, pipeline editor 101 includes an “apps list” shown in FIG. 6 as a column to the left of the workspace in which available tools are listed. In some embodiments, apps on the list can be dragged out into the workspace where they will appear as icons 103. Once a pipeline is converted into a tool, the tool is added to the Apps list in the side bar. A user can then perform a drag gesture to bring any tool (i.e., any App), including the previously-created pipeline tool, into the workspace of pipeline editor 101.

Systems described herein may be embodied in a client/server architecture. Alternatively, functionality described herein may be provided by a computer program application that runs solely on a client computer (i.e., runs locally). A client computer can be a laptop or desktop computer, a portable device such as a tablet or smartphone, or specialized computing hardware such as is associated with a sequencing instrument. For example, in some embodiments, functions described herein are provided by an analytical unit of an NGS sequencing system, accessing a database according to embodiments of the invention and assembling sequence reads from NGS and reporting results through the terminal hardware (e.g., monitor, keyboard, and mouse) connected directly to the NGS system. In some embodiments, this functionality is provided as a “plug-in” or functional component of sequence assembly and reporting software such as, for example, the GS De Novo Assembler, known as gsAssembler or Newbler (NEW assemBLER) from 454 Life Sciences, a Roche Company (Branford, Conn.). Newbler is designed to assemble reads from sequencing systems such as the GS FLX+ from 454 Life Sciences (described, e.g., in Kumar, S. et al., Genomics 11:571 (2010) and Margulies, et al., Nature 437:376-380 (2005)). In some embodiments, a production application is provided as functionality within a sequence analyzing system such as the HiSeq 2500/1500 system or the Genome AnalyzerIIX system sold by Illumina, Inc. (San Diego, Calif.) (for example, as downloadable content, an upgrade, or a software component).

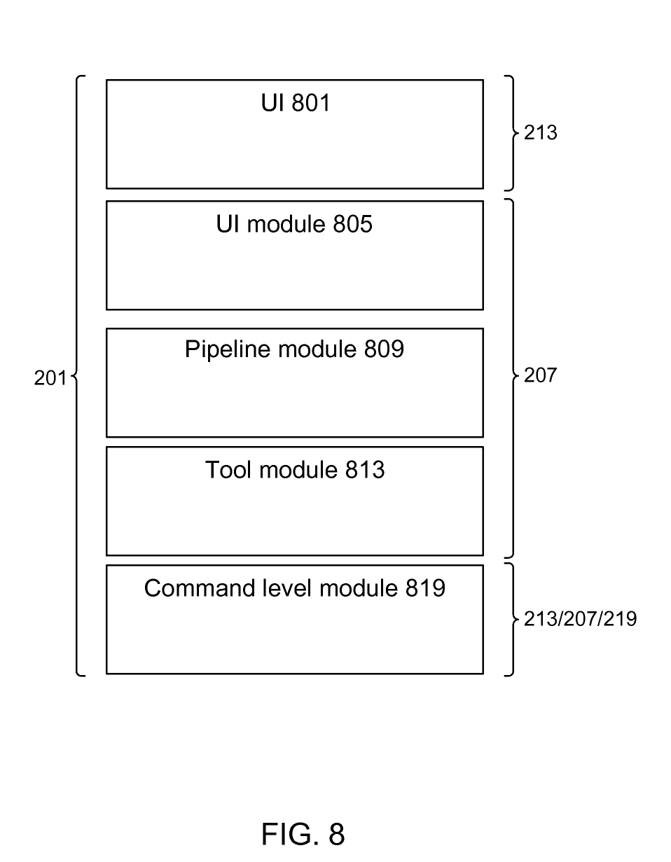

FIG. 8 illustrates components of a system 201 according to certain embodiments. Generally, a user will interact with a user interface (UI) 801 provided within, for example, local computer 213. A UI module 805 may operate within server system 207 to send instructions to and receive input from UI 801. Within server system 207, UI module 805 sits on top of pipeline module 809 which executes pipelines 113. Pipeline module 809 causes a tool module 813 to execute the individual tools 107. Tool module 813 causes the underlying tool commands to be executed by command-level module 819. Preferably, UI module 801, pipeline module 809, and tool module 813 are provided at least in part by server system 207. In some embodiments, affiliated cloud computing resource 219 contributes the functionality of one or more of UI module 801, pipeline module 809, and tool module 813. Command-level module 819 may be provided by one or more of local computer 213, server system 207, cloud computing resource 219, or a combination thereof.

Computer program instructions can be written using any suitable language known in the art including, for example, Perl, BioPerl, Python, C++, C#, JavaScript, Ruby on Rails, Groovy and Grails, or others. Program code can be linear, object-oriented, or a combination thereof. Preferably, program instructions for the functionality described here are provided as distinct modules, each with a defined functionality.

Exemplary languages, systems, and development environments include Perl, C++, Python, Ruby on Rails, JAVA, Groovy, Grails, Visual Basic .NET. In some embodiments, implementations of the invention provide one or more object-oriented application (e.g., development application, production application, etc.) and underlying databases for use with the applications. An overview of resources useful in the invention is presented in Barnes (Ed.), Bioinformatics for Geneticists: A Bioinformatics Primer for the Analysis of Genetic Data, Wiley, Chichester, West Sussex, England (2007) and Dudley and Butte, A quick guide for developing effective bioinformatics programming skills, PLoS Comput Biol 5(12):e1000589 (2009).

In some embodiments, systems of the invention are developed in Perl (e.g., optionally using BioPerl). Object-oriented development in Perl is discussed in Tisdall, Mastering Perl for Bioinformatics, O'Reilly & Associates, Inc., Sebastopol, Calif. 2003. In some embodiments, a database application, database, and production application are developed using BioPerl, a collection of Perl modules that allows for object-oriented development of bioinformatics applications. BioPerl is available for download from the website of the Comprehensive Perl Archive Network (CPAN). See also Dwyer, Genomic Perl, Cambridge University Press (2003) and Zak, CGI/Perl, 1st Edition, Thomson Learning (2002).

In certain embodiments, systems of the invention are developed using Java and optionally the BioJava collection of objects, developed at EBI/Sanger in 1998 by Matthew Pocock and Thomas Down. BioJava provides an application programming interface (API) and is discussed in Holland, et al., BioJava: an open-source framework for bioinformatics, Bioinformatics 24(18):2096-2097 (2008). Java is discussed in Liang, Introduction to Java Programming, Comprehensive (8th Edition), Prentice Hall, Upper Saddle River, N.J. (2011) and in Poo, et al., Object-Oriented Programming and Java, Springer Singapore, Singapore, 322 p. (2008).

Systems of the invention can be developed using the Ruby programming language and optionally BioRuby, Ruby on Rails, or a combination thereof. Ruby or BioRuby can be implemented in Linux, Mac OS X, and Windows as well as, with JRuby, on the Java Virtual Machine, and supports object oriented development. See Metz, Practical Object-Oriented Design in Ruby: An Agile Primer, Addison-Wesley (2012) and Goto, et al., BioRuby: bioinformatics software for the Ruby programming language, Bioinformatics 26(20):2617-2619 (2010).

Systems and methods of the invention can be developed using the Groovy programming language and the web development framework Grails. Grails is an open source model-view-controller (MVC) web framework and development platform that provides domain classes that carry application data for display by the view. Grails domain classes can generate the underlying database schema. Grails provides a development platform for applications including web applications, as well as a database and an object relational mapping framework called Grails Object Relational Mapping (GORM). The GORM can map objects to relational databases and represent relationships between those objects. GORM relies on the Hibernate object-relational persistence framework to map complex domain classes to relational database tables. Grails further includes the Jetty web container and server and a web page layout framework (SiteMesh) to create web components. Groovy and Grails are discussed in Judd, et al., Beginning Groovy and Grails, Apress, Berkeley, Calif., 414 p. (2008); Brown, The Definitive Guide to Grails, Apress, Berkeley, Calif., 618 p. (2009).

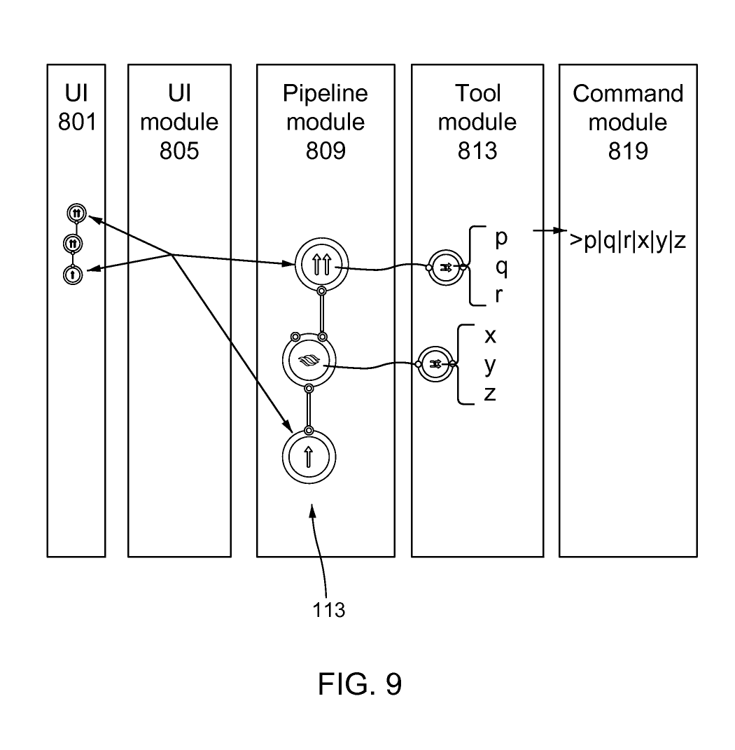

FIG. 9 illustrates the operation and inter-relation of components of systems of the invention. In certain embodiments, a pipeline 113 is stored within pipeline module 809. Pipeline 113 may be represented using any suitable language or format known in the art. In some embodiments, a pipeline is described and stored using JavaScript Object Notation (JSON). The pipeline JSON objects include a section describing nodes (nodes include tools 107 as well as input points 315 and output points 307) and a section describing the relations (i.e., connections 501) between the nodes. Pipeline module 809 may also be the component that executes these pipelines 113.

Tool module 813 manages information about the wrapped tools 107 that make up pipelines 113 (such as inputs/outputs, resource requirements, etc.)

The UI module 805 handles the front-end user interface. This module can represent workflows from pipeline module 809 graphically as pipelines in the graphical pipeline editor 101. The UI module can also represent the tools 107 that make up the nodes in each pipeline 113 as node icons 301 in the graphical editor 101, generating input points 315 and output points 307 and tool parameters from the information in tool module 813. The UI module will list other tools 107 in the “Apps” list along the side of the editor 101, from whence the tools 107 can be dragged and dropped into the pipeline editing space as node icons 301.

In certain embodiments, UI module 805, in addition to listing tools 107 in the “Apps” list, will also list other pipelines the user has access to (separated into “Public Pipelines” and “Your Custom Pipelines”), getting this information from pipeline module 809. The pipelines-as-tools are treated by the pipeline editor 101 in the same way it treats tools 107. The pipelines-as-tools can be dragged and dropped into the editing space where they show up as nodes just like tools 107. The input points 315 and output points 307 for these pipelines-as-tools are generated by UI module 805 from the input and output file-nodes in the pipeline being represented (this information is in the workflow JSON).

The parameters displayed for the pipeline-as-tool are the parameters of the underlying tools (which UI module 805 can fetch from module 813). UI module 805 can split the parameters into different categories for the different tools in the sidebar of the pipeline editor 101.

When a user stores/saves a pipeline 113 that includes a pipeline-as-tool as one of its components, the nodes and relations of the pipeline represented by the pipeline-as-tool are pasted into the workflow of the overall pipeline the user is saving. Any connections the user has drawn between the pipeline-as-tool and the rest of the overall pipeline are added as relations between the tool nodes of the pipeline-as-tool and the other nodes of the overall pipeline. Those nodes that were pasted in (i.e., those nodes that are represented by the pipeline-as-tool) have a tag added to them in the JSON to let UI module 805 know that they should all be represented by a single tool-icon 301.

When executing the overall pipeline (i.e., the pipeline with another pipeline embedded in it), pipeline module 809 simply executes the entire workflow as it would normally, ignoring the “these-are-all-represented-as-a-single-tool” tags next to certain nodes (i.e., from the perspective of pipeline module 809, the “collapsing” is completely transparent).

Using systems described herein, a wide variety of genomic analytical pipelines may be provided. In general, pipelines will relate to analyzing genetic sequence data. The variety of pipelines that can be created is open-ended and unlimited. In some embodiments, one or more pipelines may be included in system 201 as a tool for use in pipeline editor 101. For example, certain genomic analytical steps may be routine and common and thus conducive to be being offered as a pre-made pipeline. Alternatively, an analytical tool may be groundbreaking and produce surprising results, and thus may be “collapsed” into a tool 107 so that other users may execute the pipeline with ease.

To illustrate the breadth of possible analyses that can be supported using system 201 and to introduce a few exemplary pipelines that may be included for use within a system of the invention, a few example pipelines are discussed.

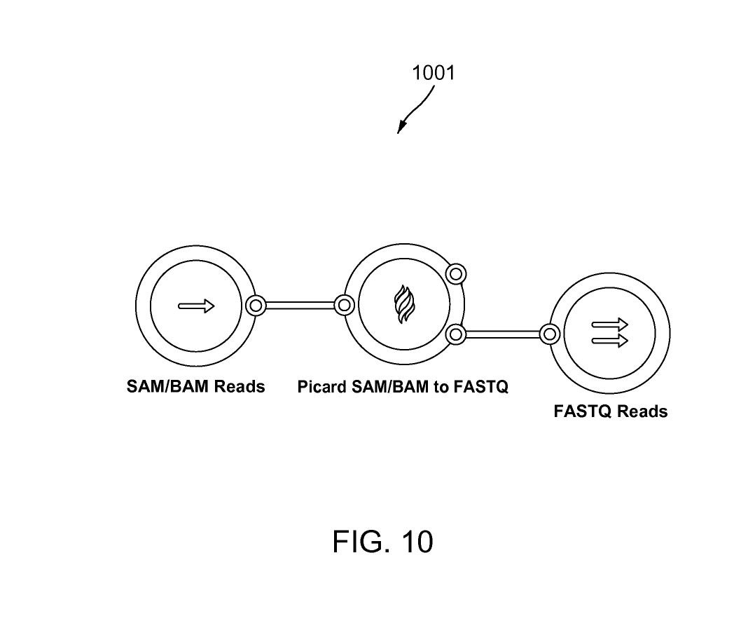

FIG. 10 illustrates a relatively simple pipeline 1001. Pipeline 1001 converts a sequence alignment map (SAM) file or a binary version of a SAM (BAM) into a FASTQ file. This allows alignment files to be processed with any pipeline that takes a standardized FASTQ input.

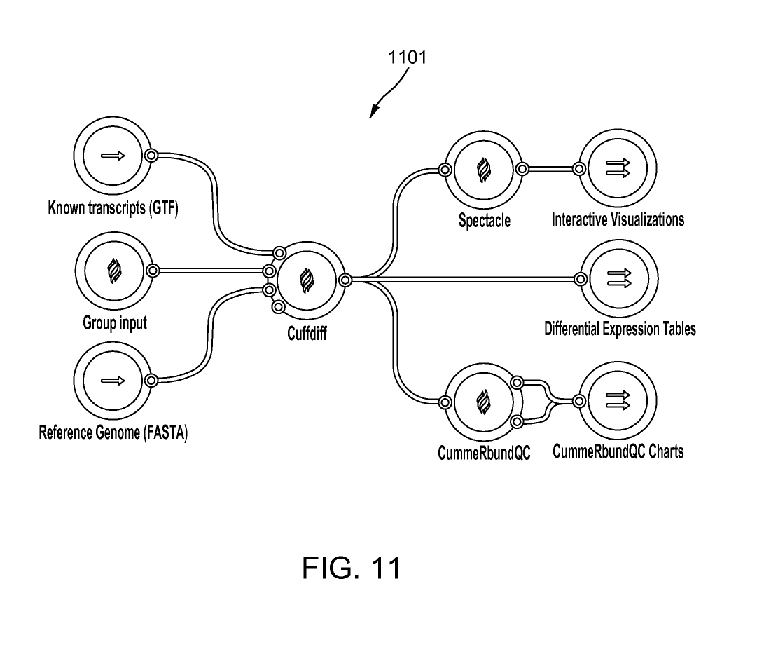

FIG. 11 shows a pipeline 1101 for differential expression analysis using the program Cuffdiff. Pipeline 1101 can find significant differences in transcript expression between groups of samples. In pipeline 1101, Cuffdiff accepts read alignment files from any number of groups containing one or more samples, it calculates expression levels at the isoform and gene level, and it tests for significant expression differences. Cuffdiff outputs a downloadable collection of files, viewable as spreadsheets that can be explored. This pipeline can also perform basic quality control of differential expression experiment powered by CummeRbund. Lastly, pipeline 1101 can render interactive visualizations from Cuffdiff results. This allows a user to explore differential expression results in the form of interactive plots, export gene sets, and generate publication quality figures.

Another analysis included in a system of the invention can provide an alignment summary.

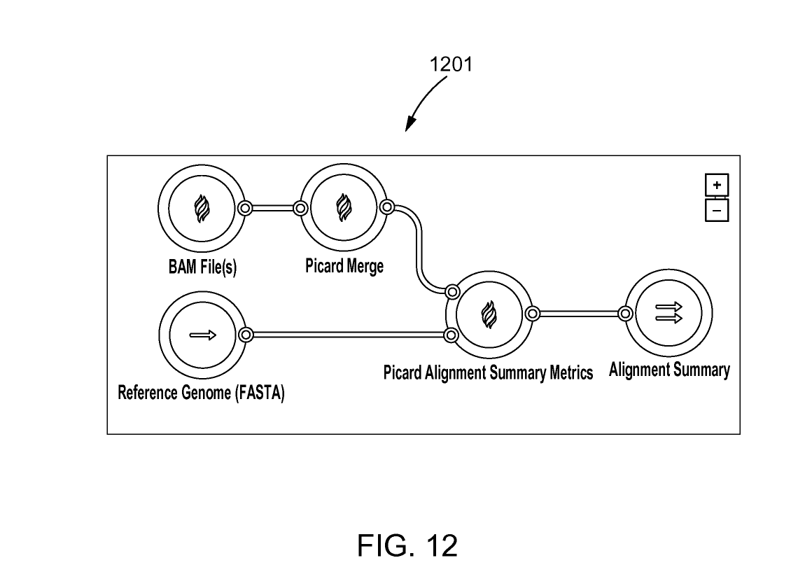

FIG. 12 shows a pipeline 1201 for providing an alignment summary. Pipeline 1201 can be used to analyze the quality of read alignment for both genomic and transcriptomic experiments. Pipeline 1201 gives useful statistics to help judge the quality of an alignment. Pipeline 1201 takes aligned reads in BAM format and a reference FASTA to which they were aligned as input, and provides a report with information such as the proportion of reads that could not be aligned and the percentage of reads that passed quality checks.

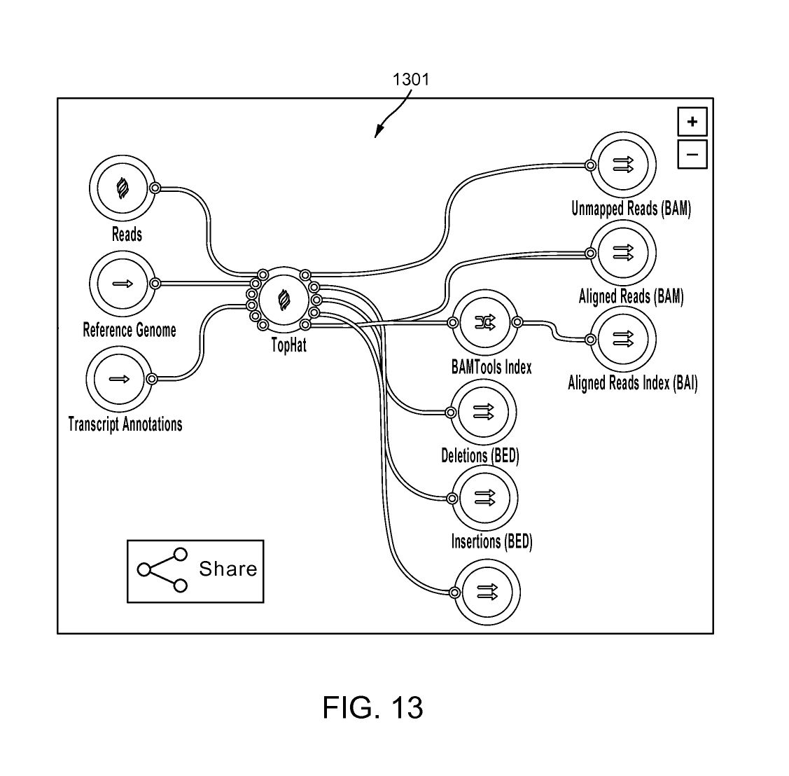

FIG. 13 depicts a pipeline 1301 for split read alignment. Pipeline 1301 uses the TopHat aligner to map sequence reads to a reference transcriptome and identify novel splice junctions. The TopHat aligner is discussed in Trapnell, et al., TopHat: discovering splice junctions with RNA-Seq. Bioinformatics 2009, 25:1105-1111, incorporated by reference. Pipeline 1301 accommodates the most common experimental designs. The TopHat tool is highly versatile and the pipeline editor 101 allows a researcher to build pipelines to exploit its many functions.

Other possible pipelines can be created or included with systems of the invention. For example, a pipeline can be provided for exome variant calling using BWA and GATK.

An exome variant calling pipeline using BWA and GATK can be used for analyzing data from exome sequencing experiments. It replicates the default bioinformatics pipeline used by the Broad Institute and the 1000 Genomes Project. GATK is discussed in McKenna, et al., 2010, The Genome Analysis Toolkit: a MapReduce framework for analyzing next-generation DNA sequencing data, Genome Res. 20:1297-303 and in DePristo, et al., 2011, A framework for variation discovery and genotyping using next-generation DNA sequencing data, Nature Genetics. 43:491-498, the contents of both of which are incorporated by reference. The exome variant calling pipeline can be used to align sequence read files to a reference genome and identify single nucleotide polymorphisms (SNPs) and short insertions and deletions (indels).

Using an exome variant-calling pipeline can illustrate the inventive system and method for collapsing pipelines into individual tools. Sometimes sequence reads for a single sample are split over multiple FASTQ files to reduce individual file size. In such a case, a user may decide to use a “Merge FASTQ files” tool upstream of the exome variant-calling pipeline to put all of the sequence read data into a single FASTQ file. The user may interact with the pipeline editor 101 to create a connection 501 with Merge FASTQ upstream and the exome variant-calling pipeline downstream. The user can then embody this new pipeline in a new single tool 107 (e.g., and give it a name such as exome variant on multiple FASTQ). In cases such as where a user anticipates repeatedly desiring to call exome variants from multiple input FASTQ files, the user may find it very beneficial to create this single tool. Additionally, the single tool can then be shared (e.g., within a lab or via publication to other, independent users). Thus, once the user has solved a particular problem, it is easy to share and replicate that solution.

As a further example, a user may create a richer version of the exome variant-calling pipeline. The user may create a version that calls variants in exomes but further includes numerous analytical features. The pipeline may not only discover genetic variation in exome sequencing samples, but also include FastQC to assess the quality of reads, Picard Alignment Summary Metrics to get an overview of the alignment and be regularly updated to include other additions such as coverage, off-target enrichment and other tools that can help determine confidence level in identified genetic variants. Each time the user updates this robust exome variant-calling pipeline, the user can create a new tool, or a new version of an existing single tool, and starting using and re-using or publishing and sharing the newly-developed pipeline.

Other pipelines that can be included in systems of the invention illustrate the range and versatility of genomic analysis that can be performed using system 201. System 201 can include pipelines that: assesse the quality of raw sequencing reads using the FastQC tool; align FASTQ sequencing read files to a reference genome and identify single nucleotide polymorphisms (SNPs); assess the quality of exome sequencing library preparation and also optionally calculate and visualize coverage statistics; analyze exome sequencing data produced by Ion Torrent sequencing machines; merge multiple FASTQ files into a single FASTQ file; read from FASTQ files generated by the Ion Proton, based on the two step alignment method for Ion Proton transcriptome data; other; or any combination of any tool or pipeline discussed herein.

The invention provides systems and methods for creating tools and integrating tools into a pipeline editor. Any suitable method of creating and integrating tools can be used. In some embodiments, a software development kit (SDK) is provided. In certain embodiments, a system of the invention includes a Python SDK. An SDK may be optimized to provide straightforward wrapping, testing, and integration of tools into scalable Apps. The system may include a map-reduce-like framework to allow for parallel processing integration of tools that do not support parallelization natively.

Apps can either be released across the platform or deployed privately for a user group to deploy within their tasks. Custom pipelines can be kept private within a chosen user group.

Systems of the invention can include tools for security and privacy. System 201 can be used to treat data as private and the property of a user or affiliated group. The system can be configured so that even system administrators cannot access data without permission of the owner. In certain embodiments, the security of pipeline editor 101 is provided by a comprehensive encryption and authentication framework, including HTTPS-only web access, SSL-only data transfer, Signed URL data access, Services authentication, TrueCrypt support, and SSL-only services access.

Additionally, systems of the invention can be provided to include reference data. Any suitable genomic data may be stored for use within the system. Examples include: the latest builds of the human genome and other popular model organisms; up-to-date reference SNPs from dbSNP; gold standard indels from the 1000 Genomes Project and the Broad Institute; exome capture kit annotations from Illumina, Agilent, Nimblegen, and Ion Torrent; transcript annotations; small test data for experimenting with pipelines (e.g., for new users).

In some embodiments, reference data is made available within the context of a database included in the system. Any suitable database structure may be used including relational databases, object-oriented databases, and others. In some embodiments, reference data is stored in a relational database such as a “not-only SQL” (NoSQL) database. In certain embodiments, a graph database is included within systems of the invention.

Using a relational database such as a NoSQL database allows real world information to be modeled with fidelity and allows complexity to be represented.

A graph database such as, for example, Neo4j, can be included to build upon a graph model. Labeled nodes (for informational entities) are connected via directed, typed relationships. Both nodes and relationships may hold arbitrary properties (key-value pairs). There need not be any rigid schema, and node-labels and relationship-types can encode any amount and type of meta-data. Graphs can be imported into and exported out of a graph data base and the relationships depicted in the graph can be treated as records in the database. This allows nodes and the connections between them to be navigated and referenced in real time (i.e., where some prior art many-JOIN SQL-queries in a relational database are associated with an exponential slowdown).

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A system for genomic analysis, the system comprising:
a server computer system comprising a processor coupled to a memory operable to cause the system to:
present to a user a plurality of genomic tools;
receive input from the user arranging the tools into a pipeline;
create a new tool that includes the pipeline; and
offer the new tool along with the plurality of genomic tools.

2. The system of claim 1, wherein each of the plurality of genomic tools and the new tool is presented using an icon displayed in a web browser on a user computer device connected to the server computer system.

3. The system of claim 1, wherein the input arranging the tools includes dragging and dropping the tools within a graphical interface.

4. The system of claim 1, further operable by the user to:
create an additional pipeline that includes the new tool;
create an additional tool that includes the additional pipeline; and
offer the plurality of genomic tools, the new tool, and the additional tool for arrangement into genomic pipelines by displaying an icon for each.

5. The system of claim 1, wherein:
a first one of the plurality of genomic tools is operable to obtain nucleotide sequence data from sequence read files,
a second one of the plurality of genomic tools is operable to align nucleotide sequence data, and
a third one of the plurality of genomic tools is operable to compare sequence reads to a reference

6. The system of claim 1, further operable to:
receive nucleotide sequence data from a remote source computer;
instruct a remote cloud computer to use the plurality of genomic tools to analyze the nucleotide sequence data; and
deliver output genomic information to a remote user computer.

7. The system of claim 1, further operable to execute the new tool in response to a user clicking a link within a document on a remote user computer.

8. The system of claim 7, further operable to execute the new tool in response to a second user clicking the link within the document after the document has been transferred to a different computer.

9. The system of claim 1, wherein offering the new tool along with the plurality of genomic tools comprises:
representing each of the plurality of genomic tools using an icon in a graphical pipeline editor on a user terminal;
representing the new tool using a new icon in the graphical pipeline editor, the new icon clickable to execute the pipeline; and
providing the graphical pipeline editor for the user to use to arrange the icons into a different pipeline.

10. The system of claim 9, further operable to represent inputs and outputs of tools graphically, and to represent inputs and outputs of pipelines in the same way that inputs and outputs of tools are represented.

11. A method for genomic analysis, the method comprising:
using a computer system comprising a processor coupled to a memory to:
present to a user a plurality of genomic tools;
receive input from the user arranging the tools into a pipeline;
create a new tool that includes the pipeline; and
offer the new tool along with the plurality of genomic tools.

12. The method of claim 11, wherein each of the plurality of genomic tools and the new tool is presented using an icon displayed in a web browser.

13. The method of claim 11, wherein the input arranging the tools includes dragging and dropping the tools within a graphical interface.

14. The method of claim 11, further comprising using the computer system to:
create an additional pipeline that includes the new tool;
create an additional tool that includes the additional pipeline; and
offer the plurality of genomic tools, the new tool, and the additional tool for arrangement into genomic pipelines.

15. The method of claim 11, wherein:
a first one of the plurality of genomic tools is operable to obtain nucleotide sequence data from sequence read files,
a second one of the plurality of genomic tools is operable to align nucleotide sequence data, and
a third one of the plurality of genomic tools is operable to compare sequence reads to a reference

16. The method of claim 11, further comprising using the computer system to:
receive nucleotide sequence data;
instruct a remote cloud computer to use the plurality of genomic tools to analyze the nucleotide sequence data; and
provide output genomic information.

17. The method of claim 11, further comprising:
representing each of the plurality of tools using an icon in a pipeline editor on a user terminal;
representing the new tool using a new icon in the pipeline editor; and
providing the pipeline editor for the user to use to arrange the icons into a different pipeline.

18. The method of claim 17, wherein the computer system operable to represent inputs and outputs of tools graphically, and to represent inputs and outputs of pipelines in the same way that inputs and outputs of tools are represented.

19. A system for genomic analysis, the system comprising:
a processor coupled to a memory containing instructions operable to cause the system to present a user interface that presents a plurality of tools, the user interface operable by a user to:
assemble individual ones of the plurality of tools into a pipeline;
create a new pipeline tool that provides the same functionality as the pipeline; and
present the new pipeline tool along with the plurality of tools.

20. The system of claim 19, wherein each of the plurality of tools and the new pipeline tool comprises instructions operable to cause the system to receive a predetermined genomic data input, change the genomic data input, and output new genomic data.

21. The system of claim 19, wherein the user interface comprises a display including an icon for each tool that can be dragged and dropped into a pipeline area of the display.

22. The system of claim 21, wherein each icon can be connected to at least one other icon by a user to cause the system to use the connected tools to analyze genomic data.

23. The system of claim 19, wherein creating the new pipeline tool comprises creating instructions that route input data to the first tool in the pipeline, and through the subsequent tools in the pipeline.

24. The system of claim 21, wherein presenting the new pipeline tool includes displaying an icon for the tool that can be dragged into the pipeline area.

25. The system of claim 24, wherein any of the pipeline tools, including the new pipeline tool, can be linked to any one or more of each other to create other pipeline.

26. The system of claim 25, further operable to store the other pipelines as new tools within the plurality of tools.

27. The system of claim 19, further operable to execute the pipeline upon receiving a request initiated by a user clicking on a link to the pipeline in a document.
